(19) United States
(12) Patent Application Publication
(10) Pub. No.: US 2017/0359407 A1
(43) Pub. Date: Dec. 14, 2017

(54) METHODS AND SYSTEMS FOR PROCESSING COMMANDS IN A DISTRIBUTED COMPUTING SYSTEM

(71) Applicant: Maximum Play, Inc., San Francisco, CA (US)

(72) Inventor: Michael Rothrock, San Francisco, CA (US)

(21) Appl. No.: 15/177,287

(22) Filed: Jun. 8, 2016

(51) Int. Cl. H04L 29/08; H04L 12/24; H04L 29/06

(52) U.S. Cl. CPC H04L 67/10; H04L 67/42; H04L 41/0806

(57) ABSTRACT

In a shared environment, commands affecting the state of an object at a plurality of client devices are assembled in an ordered manner in a command log. In a real-time implementation, commands are immediately applied to a current state of the object at respective client devices, subject to commitment (or reversal) according to confirmation (or not) that the commands have been committed to the command log. In a non-real-time implementation, commands are first presented for commitment in the command log and only after the commands have been so committed in the command log are the commands applied to the current state of an object at the client device.

### FIELD OF THE INVENTION

The present invention relates to the processing of commands in a distributed computing system, and more particularly relates to the assembling of commands received from a plurality of client devices in a command log at a server.

### BACKGROUND

In a collaborative editing environment provided by a distributed computing system, a plurality of users may edit a single object. In an editing approach using locking, only one user can edit the object at a time. The object is effectively “locked” to all users (i.e., with respect to write privileges) except to the user who is editing the object. While this editing approach may be effective in preventing the occurrence of conflicting versions of object (since only one version of the object exists at any one moment), the editing pace may be slow (with only one person editing the object at a time) and the serial editing process may thwart spontaneity and creativity (as users must wait for their turn before making a contribution).

In a lock-free approach, all users may store a local copy of an object and each user is allowed to edit their local copy at any time (hence, a lock-free approach). Each user's edits may then be transformed before being propagated to other users, in order to maintain consistency across all the local copies of the object. Formulating the transformations of edits is, however, often a complex task since edits in general may not be commutative (e.g., the result of edit 1 followed by edit 2 is different from the result of edit 2 followed by edit 1). A field of computer science called “operational transformation” is focused on the study of such transformations.

In either the locking or the lock-free approach, the focus of the collaborative editing environment is the object. Objects are created, edited and then saved. Inconsistencies between local copies of objects should be either prevented or reconciled as soon as possible.

### SUMMARY OF THE INVENTION

In accordance with one embodiment of the invention, commands related to an object received from a plurality of client devices are assembled in an ordered manner in a command log at a server (or other computing device). The commands may be ordered based on time stamps, sequence identifiers, or other parameters associated with the commands. The focus (e.g., the underlying data structure) of the collaborative editing environment is the command log, as compared to the object as in prior collaborative editing environments. To obtain the state of a object at a particular time, the command log may be sequentially “played” (i.e., executed) to a certain command in the command log, or a portion of the command log be may applied to a current state of an object at a client device.

In a real-time implementation, commands (typically different commands at each of the client devices) are immediately applied to a current state of an object at each of the client devices, and the commands may be stored in respective work logs at each of the client devices. Upon commands being confirmed by the server and incorporated into the command log at the server, the commands may be removed from the respective work log. If the commands are not confirmed by the server, the state of the object at a respective client device may be returned to a state that existed prior to applying the commands, and the commands may be removed from the respective work log. In a non-real-time implementation, commands are first transmitted from a client device to the server. Only after the commands have been confirmed by the server and stored in the command log will the commands be applied to a current state of an object at the client device.

Commands from a plurality of client devices may be conflicting or non-conflicting. Conflicting commands may be commands that are mutually exclusive with respect to the state of an object. Non-conflicting commands may be commands that are not mutually exclusive with respect to the state of an object. Non-conflicting commands may be assembled in the command log without any further consideration. Conflicting commands may be assembled in the command log with the conflicting commands each labeled with a source identifier identifying the client device associated with the command. Candidate states of an object corresponding to at least one of the conflicting commands may be computed and displayed to a user, allowing the user to select one of the candidate states and accordingly resolve one or more of the conflicts presented by conflicting commands. Alternatively, conflicting commands may be resolved based on a pre-defined policy at the server (e.g., adopt command(s) of the user with higher seniority).

In accordance with one embodiment of the invention, a server may receive a first sequence of commands from a first client device, and may receive a second sequence of commands from a second client device. At the server, a command log may be updated based on the first and second sequence of commands. The updating of the command log may comprise inserting at least one of the commands from the first sequence and at least one of the commands from the second sequence into the command log. The inserted commands may be ordered with respect to each other based on a sequence identifier associated with each of the commands in the first and second sequence of commands. Further, the server may transmit a third sequence of commands from the command log to at least one of the first and second client devices.

In accordance with one embodiment of the invention, the server may transmit the log of combined commands, which may include commands from the first and second client devices (and even a third client device, fourth client device, etc.) to all client devices. More specifically, the logs of combined commands may be transmitted in accordance with a “pull model”. In the pull model, the server may maintain a count of the total number of commands that are stored in the command log at the server. When the server appends one or more commands to the command log, the server may notify all client devices of the new count of commands. The client devices can then determine if and when commands are to be read from the command log. A client device that is performing real-time editing may immediately retrieve the next command from the command log, whereas a non-real-time client may delay the retrieval of commands, eventually retrieving a batch of all the commands that arrived since its last update.

In accordance with one embodiment of the invention, an important attribute of the command log is that the order of commands within the command log as specified by sequence identifiers is immutable. That is, once a sequence identifier has been assigned to a given command (e.g., sequence identifier=4), that sequence identifier never changes. That allows client devices, regardless of whether they are late joiners (e.g., client devices that join the collaborative editing environment later than other client devices) or slow running clients (e.g., client device with limited processing abilities, client devices with limited network bandwidth, etc.), to arrive at a consistent state of an object (i.e., state consistent across all client devices) by playing (i.e., executing) the commands in the command log to a particular sequence identifier.

These and other embodiments of the invention are more fully described in association with the drawings below.

### BRIEF DESCRIPTION OF THE DRAWINGS

FIG. 1 depicts a distributed computing system configured in accordance with one embodiment of the invention.

FIG. 2 depicts a sequence of a real-time process for carrying out commands received at a first client device, and a process for indirectly communicating one or more of these commands to a second client device, in accordance with one embodiment of the invention.

FIG. 3 depicts a sequence of a non-real-time process for carrying out commands received at a first client device, and a process for indirectly communicating one or more of these commands to a second client device, in accordance with one embodiment of the invention.

FIGS. 4A-4B depict a sequence of a real-time process for carrying out non-conflicting commands received at first and second client devices, and a process for indirectly communicating one or more of these commands between the first and second client devices, in accordance with one embodiment of the invention.

FIGS. 5A-5C depict a sequence of a real-time process for carrying out conflicting commands received at first and second client devices, and a process for indirectly communicating one or more of these commands between the first and second client devices, in accordance with one embodiment of the invention.

FIG. 6 depicts a sequence of a non-real-time process for carrying out non-conflicting commands received at first and second client devices, and a process for indirectly communicating one or more of these commands between the first and second client devices, in accordance with one embodiment of the invention.

FIGS. 7A-7C depict a sequence of a non-real-time process for carrying out conflicting commands received at first and second client devices, and a process for indirectly communicating one or more of these commands between the first and second client devices, in accordance with one embodiment of the invention.

FIG. 8 depicts components of a computer system in which computer readable instructions instantiating the methods of the present invention may be stored and executed.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. Descriptions associated with any one of the figures may be applied to different figures containing like or similar components/steps. While the sequence diagrams each present a series of steps in a certain order, the order of some of the steps may be changed.

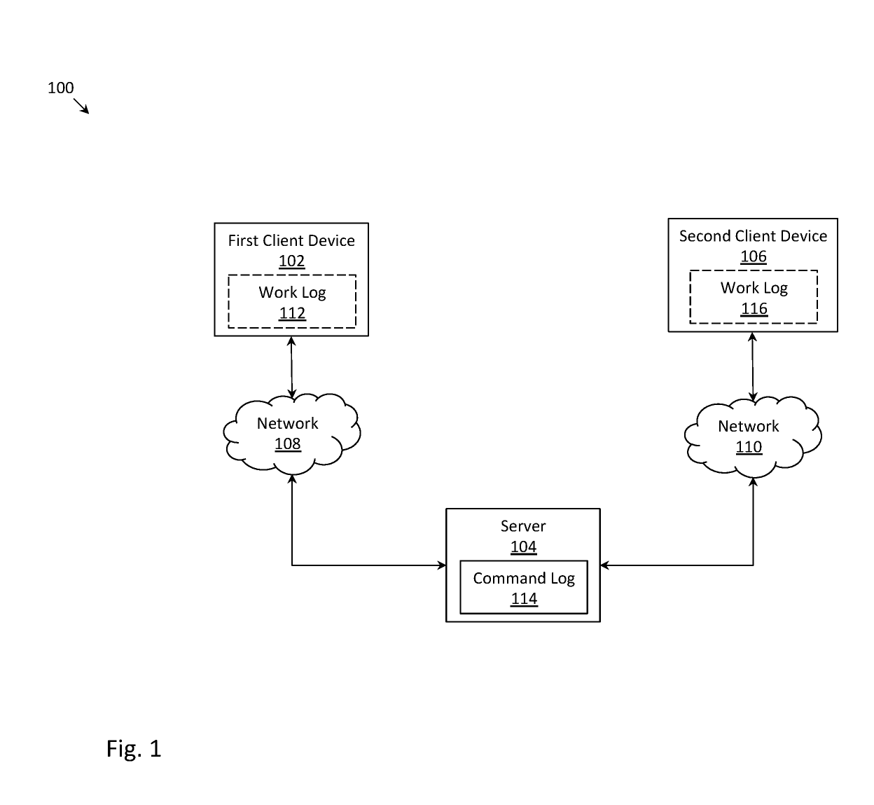

FIG. 1 depicts a distributed computing system 100 configured in accordance with one embodiment of the invention. First client device 102 may be communicatively coupled to server 104 via network 108. Similarly, second client device 106 may be communicatively coupled to server 104 via network 110. First client device 102 and second client device 106 may each be a computing device (e.g., desktop computer, laptop computer, tablet computer, smart phone, etc.) that accepts input from a user and provides output to the user. Networks 108 and 110 may be any form of communication means and, in some cases, may be individual communication links (e.g., wireless or wired), or one or more communication networks, including private networks, public networks and/or virtual private networks over public networks. While depicted as two separate networks, networks 108 and 110 may be or may share portions of a single network. Also, although only two client devices are illustrated, it should be recognized that distributed computing systems having more than two client devices are within the scope of the present invention.

The two client devices are configured with execution environments that facilitate their operating on objects. For example, each of the client devices may execute an operating system and one or more application programs, at least one of which facilitates users operating on objects. In one embodiment, the application program is a game development application and the objects comprise objects in a game under development. Objects may be any element that will be depicted in a scene and users operate on objects by issuing commands that affect the objects in some fashion. For example, commands may affect an object's visual appearance, its location relative to other objects, the manner in which the object interacts with other objects, etc. As used herein then, commands should be regarded as pertaining to an object and may comprise instructions, attributes, orders or other directives concerning the object.

While client devices 102 and 106 were described above as being user driven (e.g., accepting input from a user and providing output to the user), this is not necessarily so. In one embodiment of the invention, server 104 may be used to coordinate the processes of multiple servers (e.g., client device 102 being replaced by a second server, client device 106 being replaced by a third server, such servers being in addition to server 104). For example, commands may be generated at the second server in response to external events, such as data flowing from sensors. Another example would be a rendering farm, where multiple servers (e.g., second and third servers) are processing parts of a movie independently. If the second and third servers work at different rates, they could use server 104 to synchronize the processing of the movie.

Another example would be arbitrage, in which the second and third servers each monitors markets in different exchanges and transmits buy/sell orders to server 104 based on observed prices. Consider the second and third servers running trading algorithms, each colocated on a different market (one in Chicago, one in New York) to eliminate latency on their respective markets. In this example, each trading algorithm may update its local state based on activity in the local market. However, the two trading algorithms are working in a coordinated fashion due to server 104. Using the invention described here, the two trading algorithms could each modify a shared model of the market.

Server 104 may receive commands (sequentially or simultaneously and pertaining to the same or different objects) from first client device 102 and second client device 106 and may commit those commands to command log 114. Additionally, server 104 may transmit commands (or confirmation of same) committed to command log 114 to one or more of first client device 102 and second client device 106 for those devices to update their respective copies of the command log and to execute the commands (if not already done). First client device 102 and second client device 106 may also store work logs 112 and 116, respectively. The work logs may store commands that have been carried out at the client devices, but have not yet been confirmed by server 104. The work logs allow the actions of those commands undertaken at a respective client device to be undone in the event that server 104 (or other device) rejects those commands. The work logs have been depicted using dashed lines, as they are optional components.

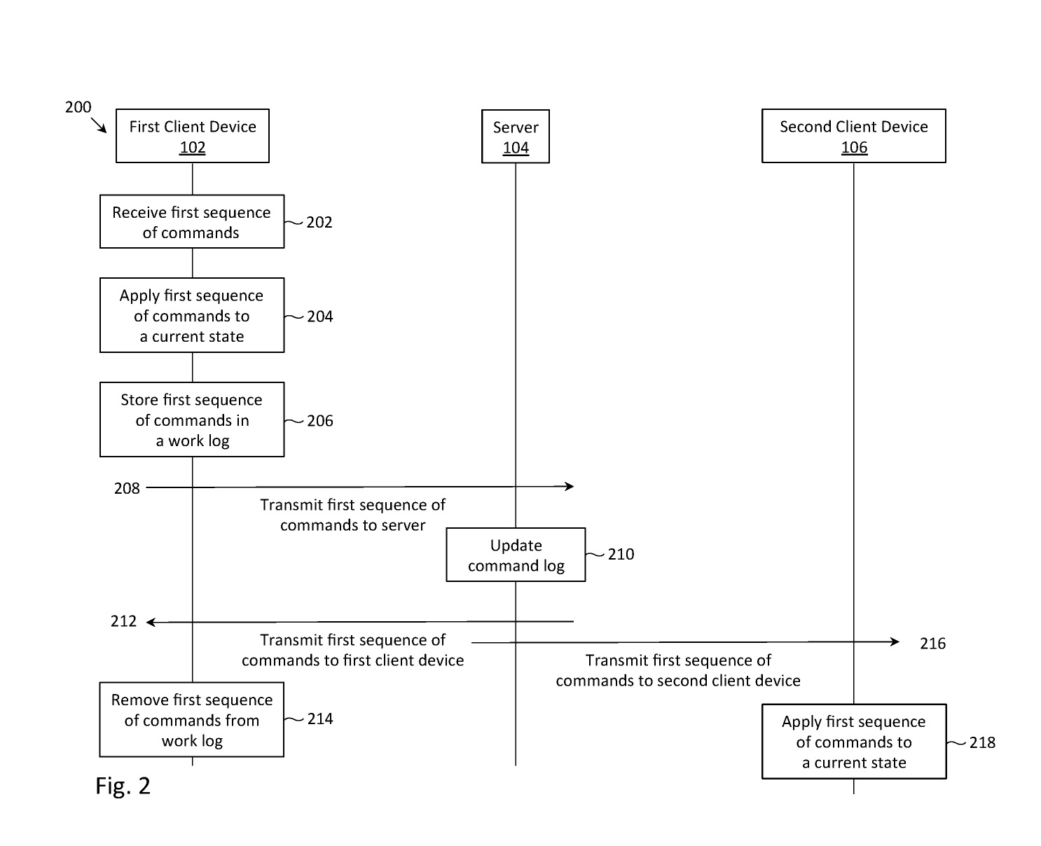

In a first scenario, only first client device 102 receives a command from the user of first client device 102. Such command may then be relayed to second client device 106 (via server 104) so that the user of second client device 106 may be apprised of the commands (and/or the resulting effects of the commands) received by first client device 102. This allows the users of first client device 102 and second client device 106 to work collaboratively (e.g., creates an impression to the users that they are collaboratively working on a single document, file, object, scene, etc.). In a second scenario, both first client device 102 and second client device 106 receive commands from their respective users in close time proximity. In such instance, two command sequences (one sequence received at first client device 102 and another sequence received at second client device 106) may be committed into one command log at server 104. If there are conflicting commands, server 104 may resolve the conflicting commands (e.g., replace conflicting commands with a single command), may defer to one or more of client devices 102 and 106 to resolve the conflicting commands, or may commit the conflicting commands without resolution. Such processes are described in more detail with reference to FIGS. 2-7 below.

FIG. 2 depicts sequence 200 of a real-time process for carrying out a first sequence of commands received at first client device 102 and for indirectly communicating one or more of these commands to second client device 106, in accordance with one embodiment of the invention. At step 202, first client device 102 may receive a first sequence of commands (e.g., move block by 5 units to the right, change color of block to red) from a user of the first client device. To clarify, the first sequence of commands may include a sequence of one command or a sequence of a plurality of commands, so the phrase “a first sequence of commands” is a shortened expression for “a first sequence of one or more commands”. Similarly, the phrase “a second sequence of commands” is a shortened expression for “a second sequence of one or more commands”.

At step 204, first client device 102 may apply the first sequence of commands to a current state of the object at the first client device. For example, the current state could comprise a blue block being located at the coordinates (X=1, Y=1) within a scene. Applying a first sequence of commands to move the block by 5 units to the right and change the color of the block to red may result in the new state comprising a red block being located at the coordinates (X=6, Y=1). The process is “real-time” because there is no perceivable time lag between steps 202 and 204 (i.e., perceivable to the user of first client device 102). That is, immediately after first client device 102 receives the first sequence of commands from the user, first client device 102 carries out the commands (i.e., applies the first sequence of commands to a current state of the object at the first client device 102). Applying the first sequence of commands to a current state of the object at the first client device may comprise providing the sequence of commands to a state machine at the first client device, such state machine computing the new state of the object based on the first sequence of commands and the current state.

While the first sequence of commands is immediately carried out in the embodiment of FIG. 2, the resulting action of those commands may or may not be permanent, depending on subsequent steps of FIG. 2. At step 206, the first sequence of commands may be stored in work log 112 at the first client device 102, indicating that the first sequence of commands (while already applied/executed at first client device 102) has yet to be confirmed by server 104 (or other device). It is noted that steps 202, 204 and 206 may be performed while first client device 102 is offline (i.e., not connected to network 108).

At step 208, first client device 102 may transmit the first sequence of commands to server 104. At step 210, server 104 may update command log 114 by appending the first sequence of commands to the end of command log 114. At step 212, server 104 may transmit the first sequence of commands back to first client device 102 to provide confirmation of the first sequence of commands. Alternatively, server 104 may transmit a message that informs first client device 102 that the first sequence of commands has been confirmed. At step 214, having received confirmation of the first sequence of commands, first client device 102 may update its copy of the command log and remove the first sequence of commands from its work log 112 (thereby making the actions of the first sequence of commands permanent, at least until further commands are received).

Further, at step 216, server 104 may transmit the first sequence of commands to second client device 106. At step 218, second client device 106 may update its copy of the command log and apply the first sequence of commands to a current state of the object at second client device 106. Steps 216 and 218 allow second client device 106 to observe the commands performed by first client device 102, thereby facilitating a collaborative work environment. It is assumed that the state of the object at first client device 102 and the state at second client device 106 are synchronized before step 202 (e.g., blue box located at coordinates X=1, Y=1 for both client devices), so that the respective states of first client device 102 and second client device 106 remain synchronized after the process of FIG. 2 has been completed (e.g., red box located at coordinates X=6, Y=1). While the process of FIG. 2 has been described with respect to two client devices, it is understood that the techniques of such a process may be applied to a distributed system with two or more client devices. In such case, the first sequence of commands may be further transmitted to a third client device, a fourth client device, etc., and further applied at those other client devices. Further, it is noted that the state common to the first client device 102 and the second client device 106 prior to step 202 could be a “zero” state (i.e., the state where no commands have yet been applied). This allows any “late joiner” client device to play back the entirety of the log to reach a common end state.

In an alternative outcome (not depicted), server 104 (or other device) may reject the first sequence of commands. In such case, in place of step 212, server 104 may transmit a message to first client device 102 indicating that the first sequence of commands has been rejected. In addition or in the alternative, server 104 may transmit to first client device 102 a sequence of commands that reverses the effects of the first sequence of commands. For example, to reverse the effects of the above described first sequence of commands, server 104 may transmit a sequence of commands to change the block color from red to blue, and move the block left by 5 units. After first client device 102 reverses the effects of the first sequence of commands (e.g., by performing the sequence of “reversal commands” transmitted by server 104 and/or using work log 112 as an undo log), first client device 102 may remove the first sequence of commands from work log 112 (step 214). Further, in the event that the first sequence of commands is rejected, steps 216 and 218 may be omitted.

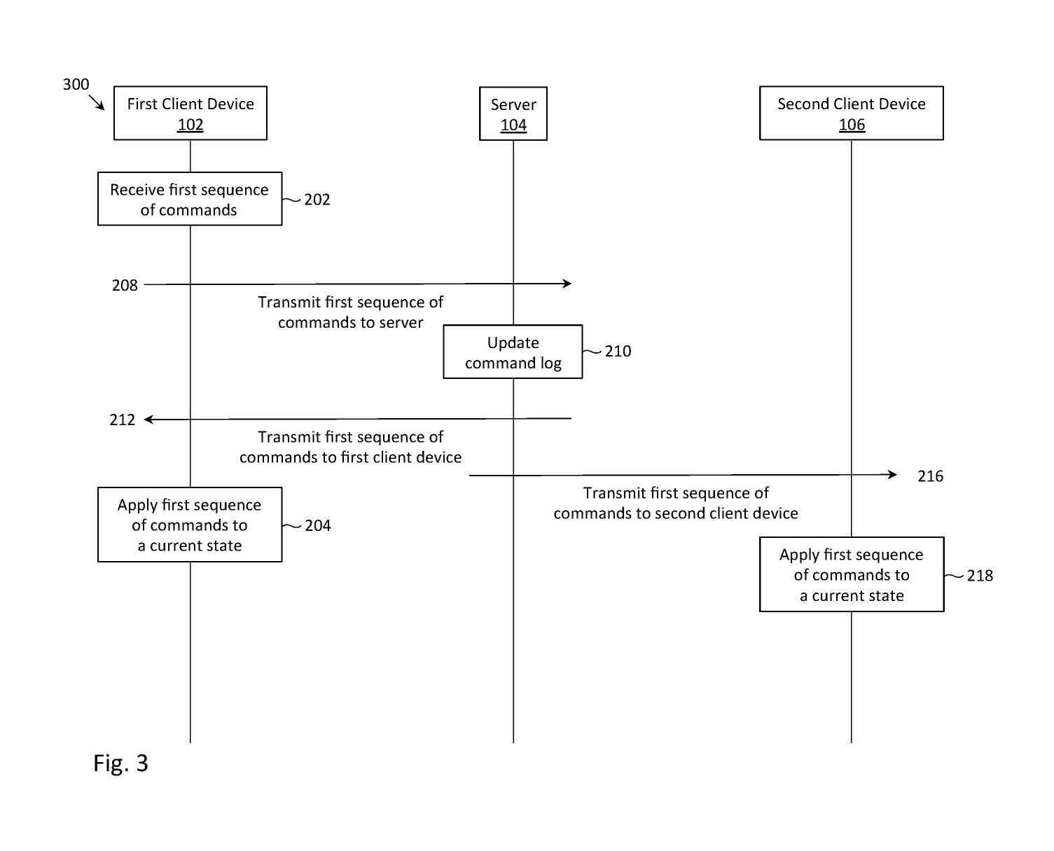

FIG. 3 depicts sequence 300 of a non-real-time process for carrying out a first sequence of commands received at first client device 102, and a process for indirectly communicating one or more of these commands to second client device 106, in accordance with one embodiment of the invention. In contrast to FIG. 2 in which the received first sequence of commands is immediately applied, the sequence of commands received at step 202 is not applied until they are confirmed by server 104 (or other device). Such delayed processing may not be appropriate for commands that a user expects to be performed immediately, but may be acceptable for commands which are not time critical. One advantage of the process of FIG. 3 is that it is more computationally efficient than the process of FIG. 2, as it does not require the use of work logs.

At step 202, first client device 102 may receive a first sequence of commands from a user of the first client device. At step 208, first client device 102 may transmit the first sequence of commands to server 104. At step 210, server 104 may update command log 114 by appending the first sequence of commands to the end of command log 114. At step 212, server 104 may transmit the first sequence of commands back to first client device 102 to provide confirmation of the first sequence of commands. At step 204, upon receiving confirmation of the first sequence of commands, first client device 102 may apply the first sequence of commands to a current state of the first client device. Further, at step 216, server 104 may transmit the first sequence of commands to second client device 106. At step 218, second client device 106 may apply the first sequence of commands to a current state of second client device 106. Copies of the command logs at the respective clients are updated accordingly.

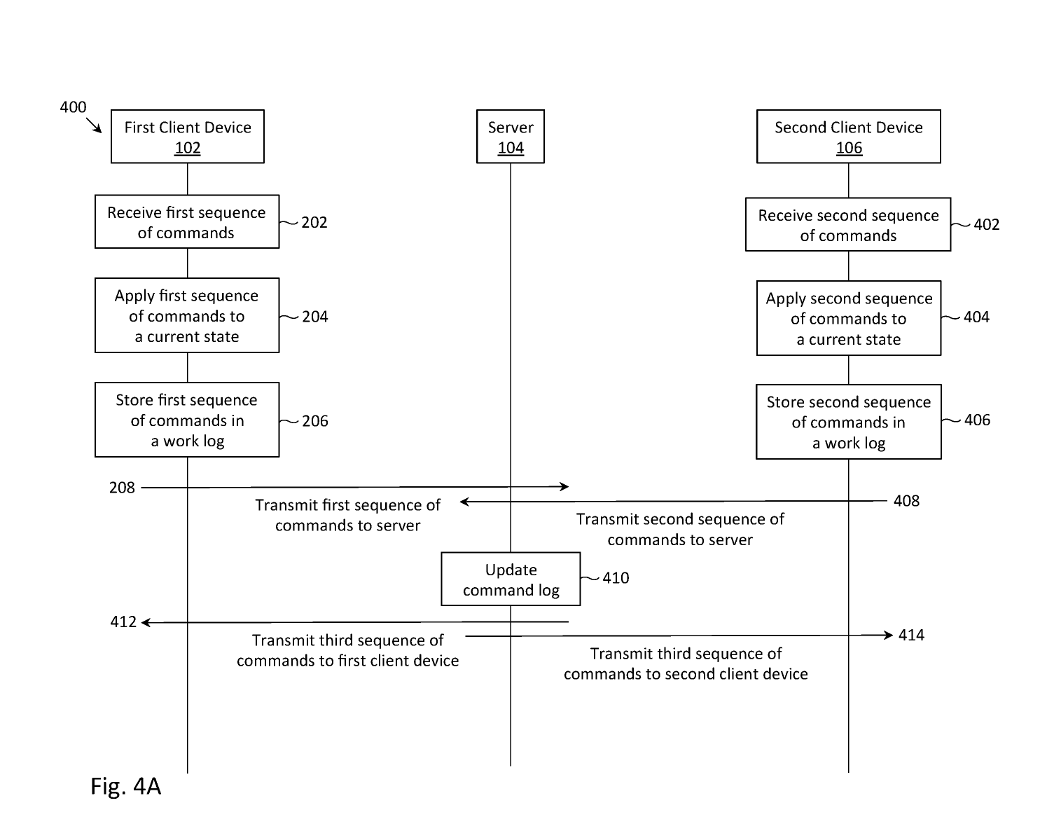

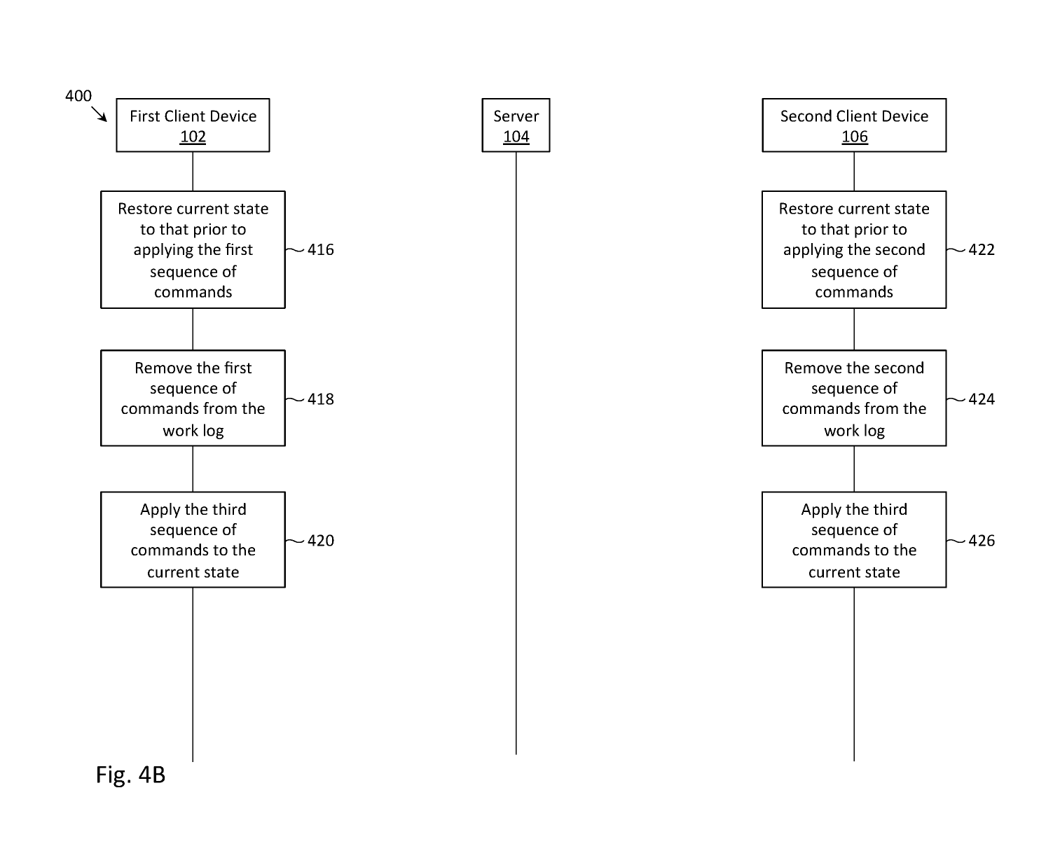

FIGS. 4A-4B depict sequence 400 of a real-time process for carrying out commands received at first client device 102, a real-time process for carrying out commands received at second client device 106, and a process for indirectly communicating one or more of these commands between the first and second client devices, in accordance with one embodiment of the invention. The steps of receiving a first sequence of commands (step 202), applying the first sequence of commands to a current state (step 204), and storing the first sequence of commands in a work log (step 206) are similar to the steps described above with respect to FIG. 2, and so need not be described again. In FIG. 4A, in addition to a first sequence of commands being received at first client device, a second sequence of commands is received at second client device 106 (step 402). At step 404, the second sequence of commands may be applied to a current state of an object at second client device 106. At step 406, the second sequence of commands may be stored in work log 116 of second client device 106. At step 408, second client device 106 may transmit the second sequence of commands to server 104.

At step 410, server 104 may update command log 114 based on the first and second sequence of commands. The updating may include inserting at least one of the commands from the first sequence and at least one of the commands from the second sequence into command log 114. In one embodiment of the invention, the updating may include inserting all commands from each of the first and second sequences, either individually or in batches, into command log 114. The inserted commands may be ordered with respect to each other based on a sequence identifier associated with each of the commands in the first and second sequence of commands. In one embodiment of the invention, the sequence identifier may be a time stamp (e.g., identifying the time that the command was received at server 104, identifying the time that the command was sent from first client device 102 or second client device 106, identifying the time that the command was received from the user by first client device 102 or second client device 106, etc.). In another embodiment of the invention, the sequence identifiers may be a strictly increasing (or decreasing) sequence, with each successive sequence identifier being assigned upon the arrival of the next command at server 104.

In one embodiment, in addition to each command being tagged with a sequence identifier, each command may be tagged with a source identifier, allowing server 104 to identify whether first client device 102 or second client device 106 generated the command. The source identifier also allows server 104 to identify whether two commands conflict (or do not conflict), as described below.

It is noted that the sequence of steps 208, 408 and 410 may vary from the order depicted in FIG. 4A. For instance, the second sequence of commands may be received before the first sequence of commands. As another possibility, some commands from the first sequence may be received (i.e., a portion of step 208), followed by an update to the command log (i.e., a portion of step 410), followed by the reception of some commands from the second sequence (i.e., a portion of step 408), followed by an update to the command log (i.e., a portion of step 208), etc.

As mentioned above, the command log may contain conflicting commands or non-conflicting commands. Generally, two conflicting commands may refer to a command from first client device 102 and a command from second client device 106 which are mutually exclusive. For example, a command from first client device 102 to move a block three units to the left will conflict with a command from second client device 106 to move the same block five units to the right, since a block cannot at the same time be located at two locations. Similarly, commands from each of the respective clients to locate different objects at the same spatial location may conflict if the simulated physics of the environment in which the objects exist do not permit such co-location or superposition. Conversely, two non-conflicting commands may refer to a command from first client device 102 and a command from second client device 106 which are not mutually exclusive. For example, a command from first client device 102 to move a block three units to the left will not conflict with a command from second client device 106 to change the color of the block to red, since a block can at the same time be located three units to the left and be colored red. Source identifiers are important for identifying whether two commands conflict, since the same two commands (e.g., move block five units to the right, move block three units to the left) will not conflict if they were to originate from the same client device (e.g., there is no conflict with sequentially moving a block five units to the right, followed by moving the block three units to the left).

Assuming the updated command log does not contain any conflicting commands, a third sequence of commands may be transmitted to the first client device (step 412) and to the second client device (step 414). The third sequence of commands may include the updates to the command log from both the first client device and the second client device (e.g., move block three units to the left, change color of block to red). At step 416, first client device 102 may restore the current state of the object at the first client device to a previous state that existed immediately prior to applying the first sequence of commands (i.e., effectively undoing effects of commands in work log 112). At step 418, first client device 102 may remove the first sequence of commands from work log 112. Finally, at step 420, first client device 102 may update its copy of the command log and apply the third sequence of commands to the current state of the object at the first client device. It is noted that, in some instances, the process of undoing the work log and then effectively redoing the commands (when applying the third sequence of commands) may appear wasteful and/or unnecessary. Nevertheless, there will be instances when commands in the command log are not commutative (i.e., order of commands changes the end result), and applying the entire third sequence of commands is more robust than selectively applying commands in the third sequence which are not present in the work log.

Similarly, at step 422, second client device 106 may restore the current state of the object at the second client device to a previous state that existed immediately prior to applying the second sequence of commands (i.e., effectively undoing effects of commands in work log 116). At step 424, second client device 106 may remove the second sequence of commands from work log 116. At step 426, second client device 106 may update its copy of the command log and apply the third sequence of commands to the current state of the object at the second client device.

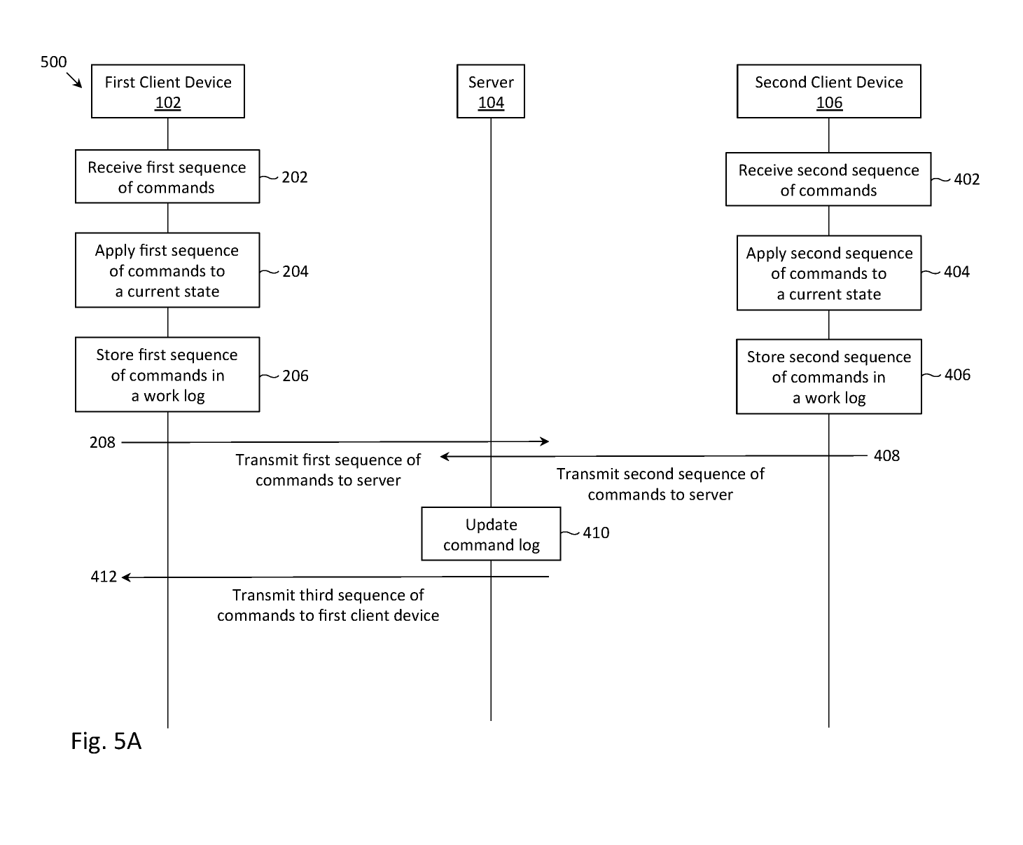

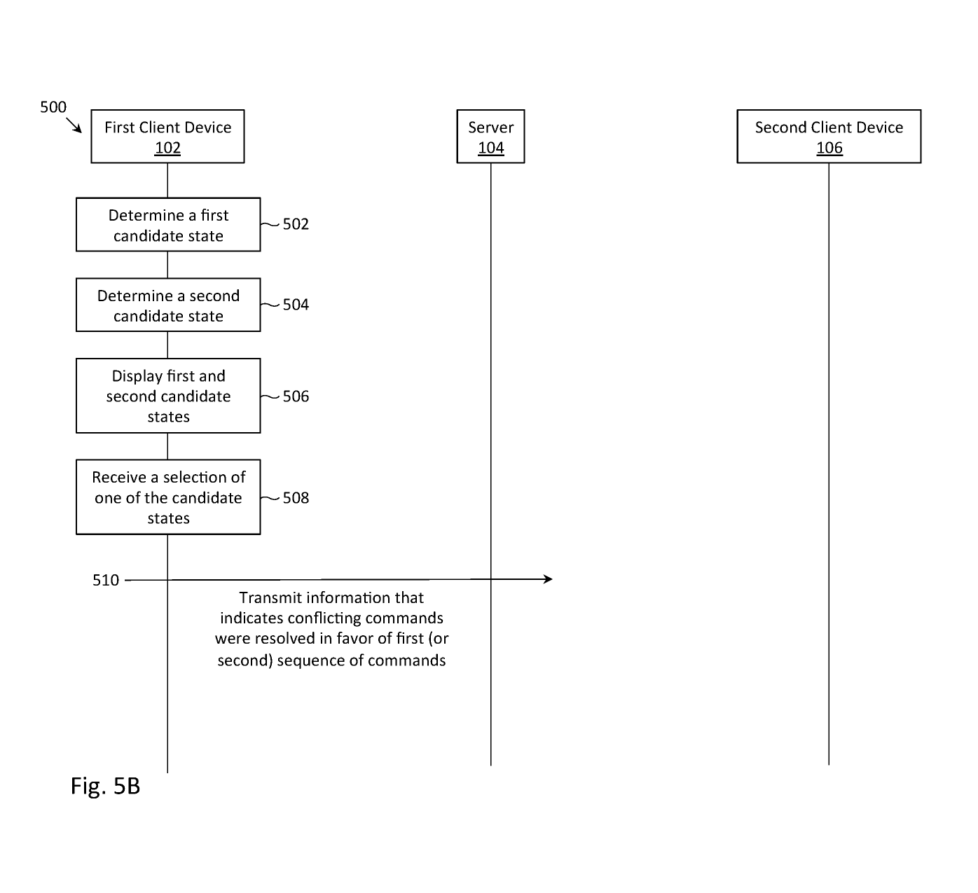

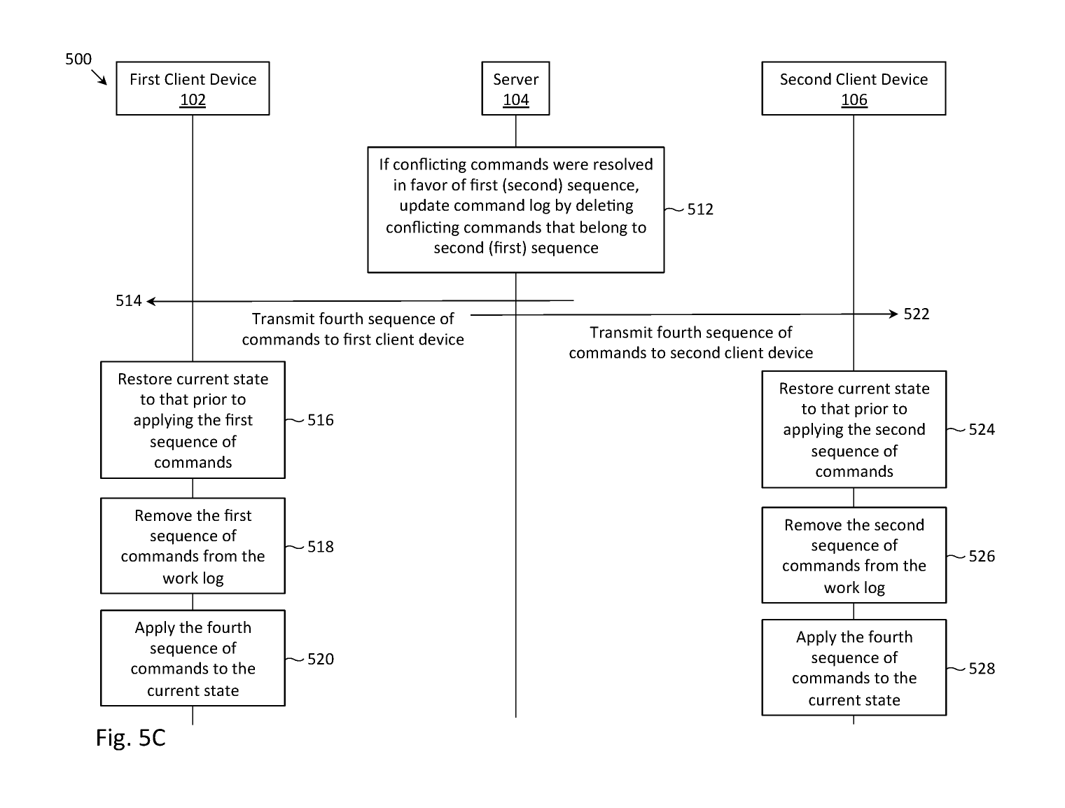

In contrast to sequence diagram 400 depicted in FIGS. 4A-4B that addressed the scenario in which the updated command log did not contain conflicting commands, sequence 500 depicted in FIGS. 5A-5C addresses the scenario in which the updated command log does contain conflicting commands. In FIGS. 5A-5C, a process is performed that allows conflicting commands to be resolved by seeking the input of one of the users. The input of the user of first client device 102 is relied upon in FIGS. 5A-5C, while in another embodiment (not depicted), the input of the user of second client device 106 could be relied upon instead.

For ease of explanation, the process of FIGS. 5A-5C will be described with respect to an exemplary first and second sequence of commands. Suppose the first sequence of commands included (sequence ID=1, move block by 5 units to the right; sequence ID=3, change color of block to red) and the second sequence of commands included (sequence ID=2, move block by 3 units to the left; sequence ID=4, change color of block to green). At step 410, the command log at server 104 would be updated to include the following command sequence (sequence ID=1, source identifier=1, command=move block by 5 units to the right; sequence ID=2, source identifier=2, command=move block by 3 units to the left; sequence ID=3, source identifier=1, command=change color of block to red; sequence ID=4, source identifier=2, command=change color of block to green). Such command sequence may be transmitted to first client device 102 in step 412.

At step 502, first client device 102 may determine a first candidate state. The first candidate state may be determined by determining a previous state of the object at first client device 102 that existed immediately prior to applying the first sequence of commands, applying the third sequence of commands to the previous state of the object at first client device 102, and for the conflicting commands within the third sequence, applying only commands from the first sequence to the previous state. Supposing the previous state of the object at first client device 102 was a blue block at the position (X=1, Y=1), the first candidate state would be a red block at the position (X=6, Y=1).

At step 504, first client device 102 may determine a second candidate state. The second candidate state may be determined by applying the third sequence of commands to the previous state of the object at first client device 102 (i.e., the previous state determined in step 502), and for the conflicting commands within the third sequence, applying only commands from the second sequence to the previous state. Supposing the previous state of the object at first client device 102 was a blue block at the position (X=1, Y=1), the second candidate state would be a green block at the position (X=−2, Y=1).

At step 506, first client device 102 may display representations of the object in both the first and second candidate states. For example, representations of the object in the first and second candidate states may be simultaneously displayed in a side-by-side manner on a display of first client device 102. Alternatively, representations of the object in the first and second candidate states may be displayed in a temporally successive manner on a display of the first client device (i.e., first candidate state followed by the second candidate state, or second candidate state followed by the first candidate state). It is understood that in step 506, while displaying representations of the object in the first and second candidate states, first client device 102 may also request the user of first client device 102 to select which representation of the object, the first or the second candidate state, should be retained.

At step 508, first client device 102 may receive a selection of one representation of the object in one of the candidate states from the user of first client device 102. At step 510, first client device 102 may transmit information to server 104 that indicates whether the conflicting commands were resolved in favor of the first or second sequence of commands. If the conflicting commands were resolved in favor of the first sequence, server 104 may update the command log by deleting conflicting commands that belong to the second sequence (step 512). Alternatively, if the conflicting commands were resolved in favor of the second sequence, server 104 may update the command log by deleting conflicting commands that belong to the first sequence (step 512). In a variation of step 512, conflicting commands are not deleted from the command log. Instead, server 104 may inject a new command into the command log that effectively reads “undo command X”, where command X is the command that has been rejected. In such a scheme of managing conflicting commands in the command log, the entire editing history of the command log may be preserved.

At step 514, a fourth sequence of commands may be sent to first client device 102. The fourth sequence of commands may include the third sequence of commands except with any conflicting commands within the third sequence replaced with commands from the first sequence (if the user selected the first candidate state) or replaced with commands from the second sequence (if the user selected the second candidate state). At step 516, first client device 102 may restore the current state of the object at the first client device 102 to the previous state that existed immediately prior to applying the first sequence of commands. At step 518, first client device 102 may remove the first sequence of commands from work log 112. At step 520, first client device 102 may update its copy of the command log and apply the fourth sequence of commands to the current state of first client device 102. In another embodiment, it is noted that step 514 may be omitted, and further that first client device 102 could apply the third sequence of commands to the current state (which it already received at step 412), except that for conflicting commands, commands from the second sequence are ignored (if the first candidate state were chosen) or commands from the first sequence are ignored (if the second candidate state were chosen).

Similarly, at step 522, the fourth sequence of commands may be sent to second client device 106. At step 524, second client device 106 may restore the current state of the object at the second client device 106 to the previous state that existed immediately prior to applying the second sequence of commands. At step 526, second client device 106 may remove the second sequence of commands from work log 116. At step 528, second client device 106 may update its copy of the command log and apply the fourth sequence of commands to the current state of second client device 106.

While the embodiment of FIGS. 5A-5C resolved conflicting commands based on the input of one user, conflicting commands may be resolved in other ways. In accordance with another embodiment of the invention, conflicting commands may be resolved at server 104 based on a pre-defined policy. For instance, two conflicting commands may be resolved by adopting the command of whichever user/client has a higher seniority/priority, whichever command was received first, etc. In accordance with another embodiment of the invention, conflicting commands may be resolved based on the input from multiple users. If there are a large number of users, the user input may be in the form of a vote. If a plurality, majority, or other threshold number of users vote that a conflict should be resolved in a certain fashion, then resolution of the conflicting commands may be based on that decision.

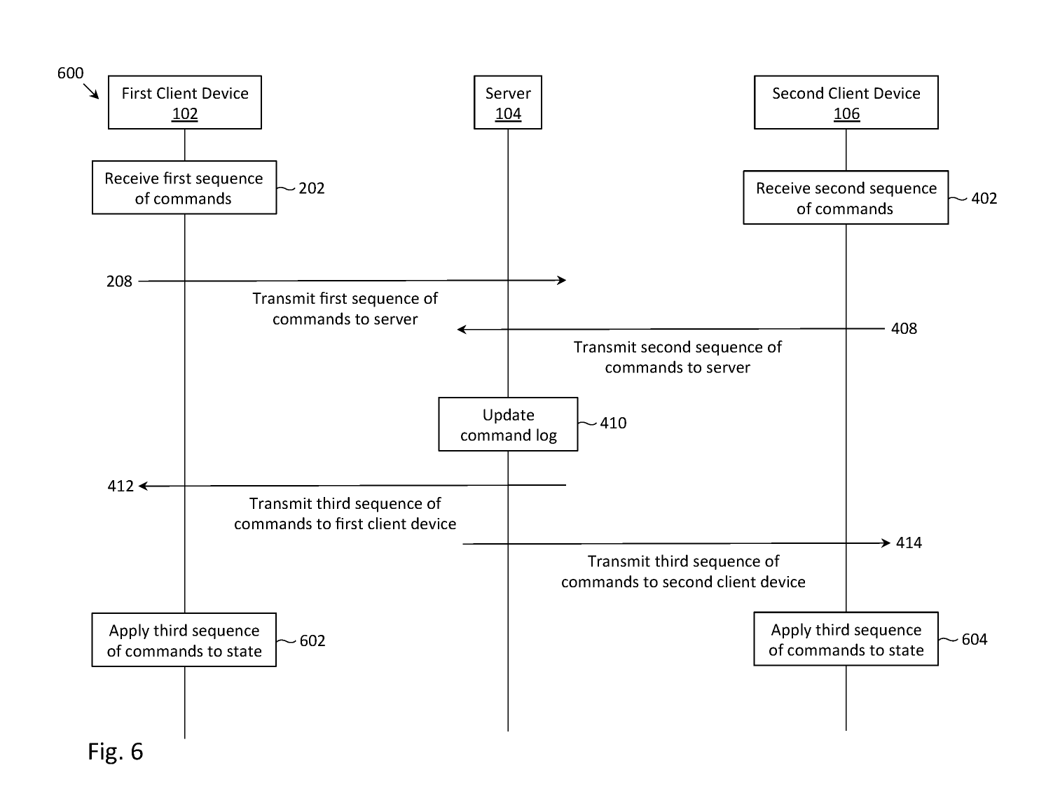

FIG. 6 depicts sequence 600 of a non-real-time process for carrying out non-conflicting commands received at first client device 102 and second client device 106, and a process for indirectly communicating one or more of these commands between the first and second client devices, in accordance with one embodiment of the invention. At step 202, first client device 102 may receive a first sequence of commands from a user of first client device 102. At step 208, first client device 102 may transmit the first sequence of commands to server 104. Similarly, at step 402, second client device 106 may receive a second sequence of commands from a user of second client device 106. At step 408, second client device 106 may transmit the second sequence of commands to server 104. At step 410, server 104 may update command log 114 based on the first and second sequence of commands. The updating may include inserting at least one of the commands from the first sequence and at least one of the commands from the second sequence into command log 114. Assuming the updated command log does not contain any conflicting commands, a third sequence of commands may be transmitted to the first client device (step 412) and to the second client device (step 414). The third sequence of commands may include the updates to the command log. At steps 602, 604, the third sequence of commands may be applied to the client devices' respective copies of the command log and to the states of the objects.

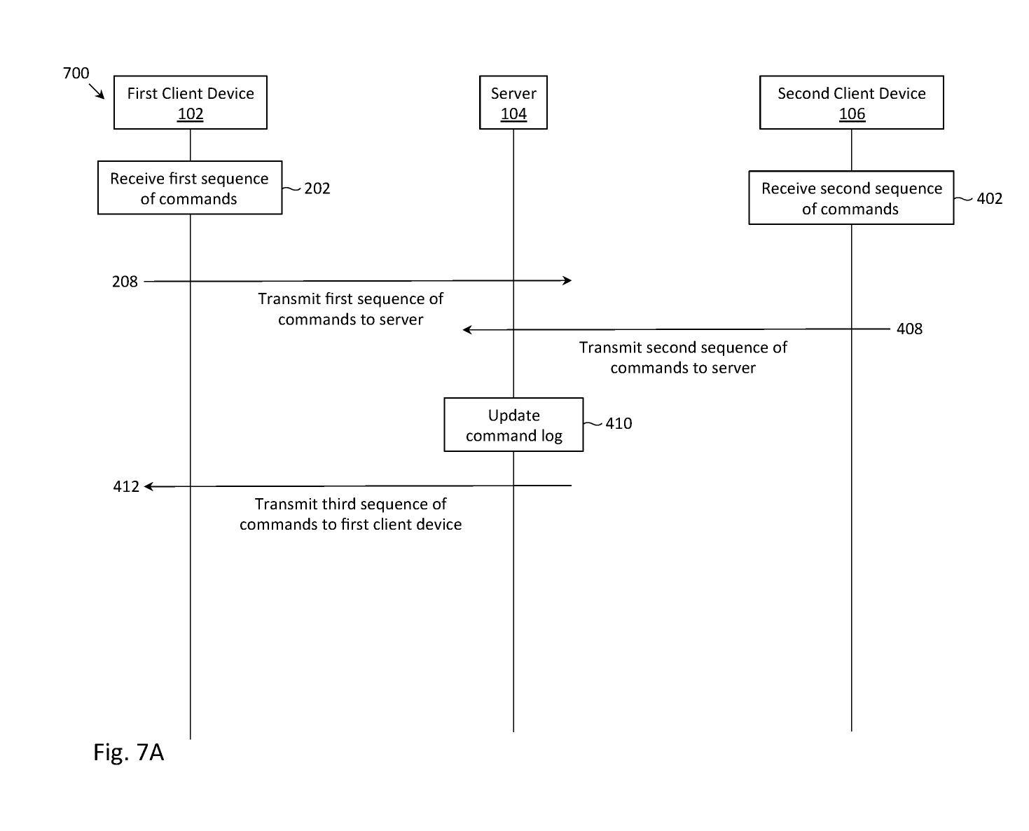

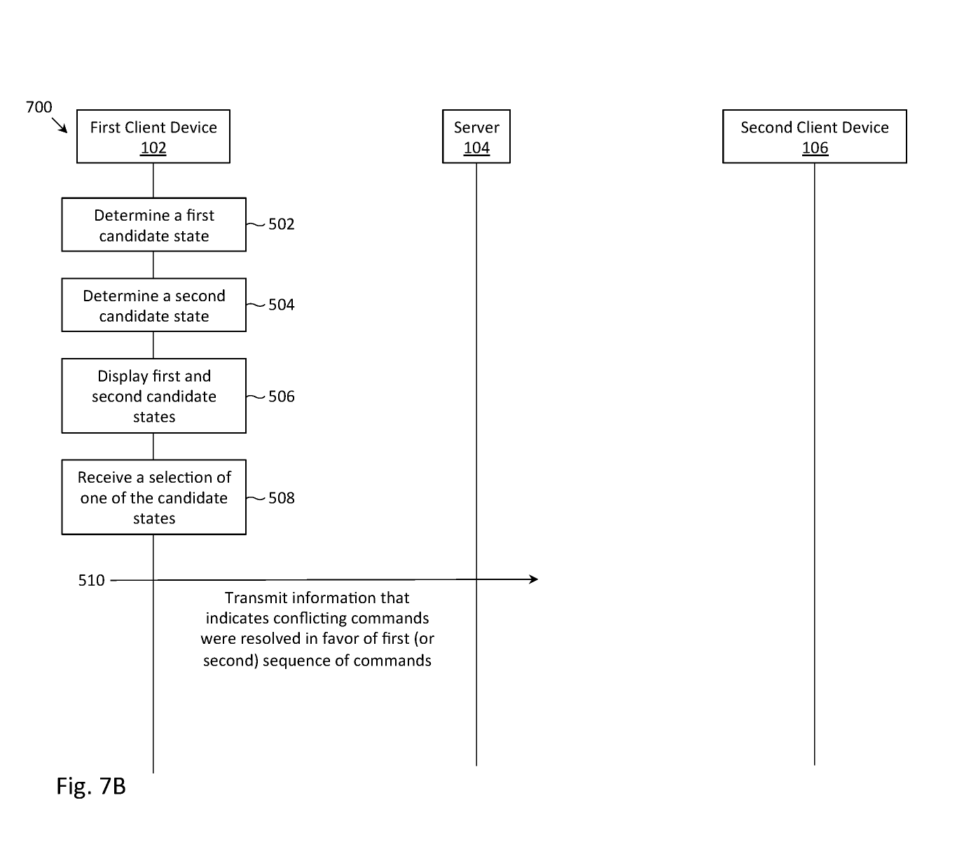

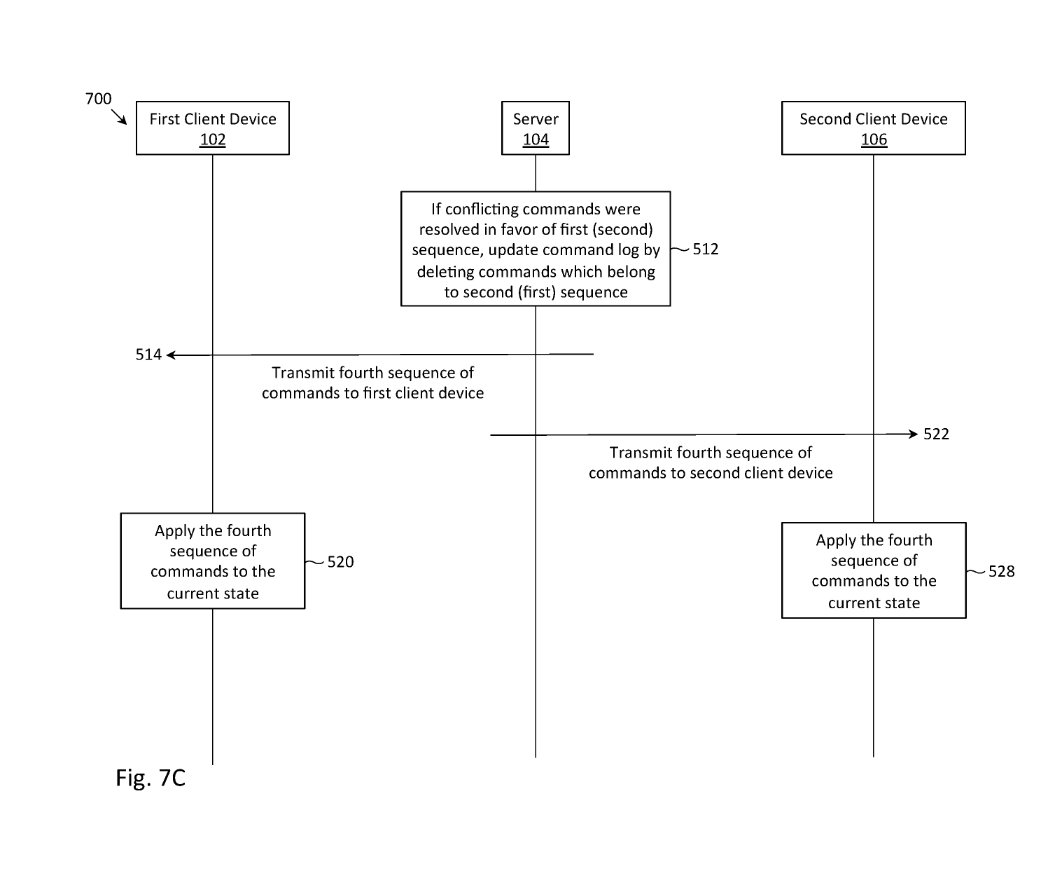

In contrast to sequence diagram 600 depicted in FIG. 6 that addressed the scenario in which the updated command log did not contain conflicting commands, sequence diagram 700 of FIGS. 7A-7C addresses the scenario in which the updated command log does contain conflicting commands. In FIGS. 7A-7C, a process is performed that allows conflicting commands to be resolved by seeking the input of one of the users. The input of the user of first client device 102 is relied upon in FIGS. 7A-7C, while in another embodiment (not depicted), the input of the user of second client device 106 could be relied upon instead.

FIG. 7A depicts steps that are present in FIG. 6, and will not be described again for conciseness. In FIG. 7B, after the third sequence of commands has been received by first client device 102, first client device 102 may determine a first candidate state (step 502) and determine a second candidate state (step 504). At step 506, representations of the object in the first and second candidate states may be displayed to the user of first client device 102, and in addition, first client device 102 may also request the user of first client device 102 to select one of the first or the second candidate states. At step 508, first client device 102 may receive a selection of one of the candidate states from the user of the first client device. At step 510, first client device 102 may transmit information to server 104 that indicates whether the conflicting commands were resolved in favor of the first or second sequence of commands. If the conflicting commands were resolved in favor of the first sequence, server 104 may update the command log by deleting conflicting commands that belong to the second sequence (step 512). Alternatively, if the conflicting commands were resolved in favor of the second sequence, server 104 may update the command log by deleting conflicting commands that belong to the first sequence (step 512).

At step 514, a fourth sequence of commands may be sent to first client device 102. The fourth sequence of commands may include the third sequence of commands except with any conflicting commands within the third sequence replaced with commands from the first sequence (if the user selected the first candidate state) or replaced with commands from the second sequence (if the user selected the second candidate state). At step 520, first client device 102 may update its command log and apply the fourth sequence of commands to the current state of the object at the first client device 102. Similarly, at step 522, the fourth sequence of commands may be sent to second client device 106, and at step 528, second client device 106 may update its command log and apply the fourth sequence of commands to the current state of the object at the second client device 106.

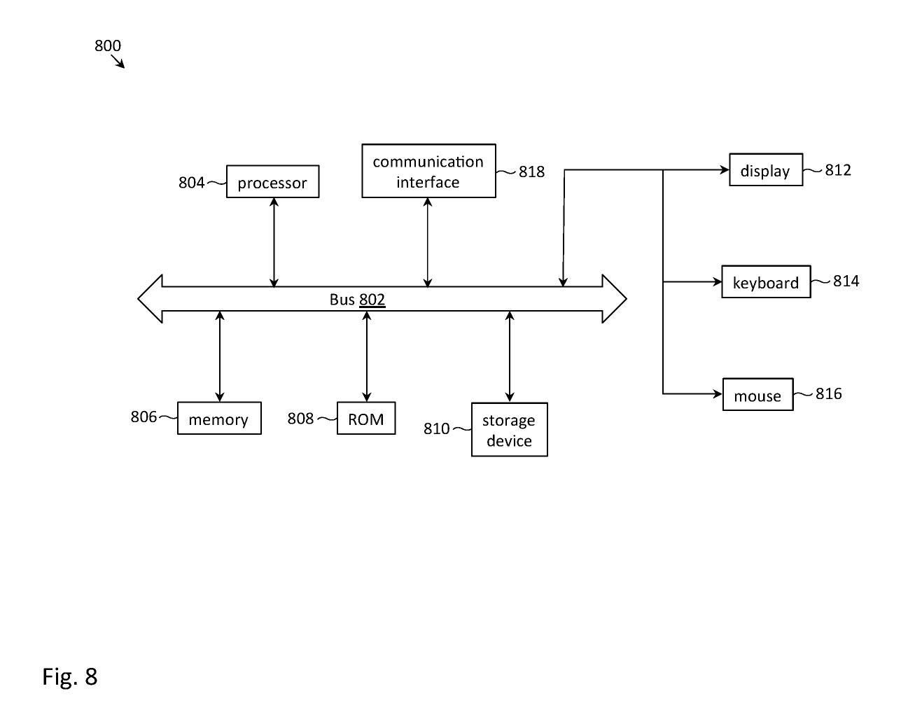

As is apparent from the foregoing discussion, aspects of the present invention involve the use of various computer systems and computer readable storage media having computer-readable instructions stored thereon. FIG. 8 provides an example of a system 800 that is representative of any of the computing systems discussed herein. Note, not all of the various computer systems have all of the features of system 800. For example, certain ones of the computer systems discussed above may not include a display inasmuch as the display function may be provided by a client computer communicatively coupled to the computer system or a display function may be unnecessary. Such details are not critical to the present invention.

System 800 includes a bus 802 or other communication mechanism for communicating information, and a processor 804 coupled with the bus 802 for processing information. Computer system 800 also includes a main memory 806, such as a random access memory (RAM) or other dynamic storage device, coupled to the bus 802 for storing information and instructions to be executed by processor 804. Main memory 806 also may be used for storing temporary variables or other intermediate information during execution of instructions to be executed by processor 804. Computer system 800 further includes a read only memory (ROM) 808 or other static storage device coupled to the bus 802 for storing static information and instructions for the processor 804. A storage device 810, for example a hard disk, flash memory-based storage medium, or other storage medium from which processor 804 can read, is provided and coupled to the bus 802 for storing information and instructions (e.g., operating systems, applications programs and the like).

Computer system 800 may be coupled via the bus 802 to a display 812, such as a flat panel display, for displaying information to a computer user. An input device 814, such as a keyboard including alphanumeric and other keys, may be coupled to the bus 802 for communicating information and command selections to the processor 804. Another type of user input device is cursor control device 816, such as a mouse, a trackpad, or similar input device for communicating direction information and command selections to processor 804 and for controlling cursor movement on the display 812. Other user interface devices, such as microphones, speakers, etc. are not shown in detail but may be involved with the receipt of user input and/or presentation of output.

The processes referred to herein may be implemented by processor 804 executing appropriate sequences of computer-readable instructions contained in main memory 806. Such instructions may be read into main memory 806 from another computer-readable medium, such as storage device 810, and execution of the sequences of instructions contained in the main memory 806 causes the processor 804 to perform the associated actions. In alternative embodiments, hard-wired circuitry or firmware-controlled processing units may be used in place of or in combination with processor 804 and its associated computer software instructions to implement the invention. The computer-readable instructions may be rendered in any computer language.

In general, all of the above process descriptions are meant to encompass any series of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying”, “receiving”, “transmitting” or the like, refer to the action and processes of an appropriately programmed computer system, such as computer system 800 or similar electronic computing device, that manipulates and transforms data represented as physical (electronic) quantities within its registers and memories into other data similarly represented as physical quantities within its memories or registers or other such information storage, transmission or display devices.

Computer system 800 also includes a communication interface 818 coupled to the bus 802. Communication interface 818 may provide a two-way data communication channel with a computer network, which provides connectivity to and among the various computer systems discussed above. For example, communication interface 818 may be a local area network (LAN) card to provide a data communication connection to a compatible LAN, which itself is communicatively coupled to the Internet through one or more Internet service provider networks. The precise details of such communication paths are not critical to the present invention. What is important is that computer system 800 can send and receive messages and data through the communication interface 818 and in that way communicate with hosts accessible via the Internet.

Thus, methods and systems for processing commands in a distributed computing system have been described. It is to be understood that the above-description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A method for a distributed computing system including a first client device, a second client device and a server, the first client device and the second client device each communicatively coupled to the server, the method comprising:
receiving at the server a first sequence of commands relating to an object at the first client device from the first client device;
receiving at the server a second sequence of commands relating to an object at the second client device from the second client device;
updating at the server a command log based on the first and second sequence of commands, by inserting at least one of the commands from the first sequence of commands and at least one of the commands from the second sequence of commands into the command log, the inserted commands being ordered with respect to each other based on a sequence identifier associated with each of the commands in the first and second sequence of commands; and
transmitting from the server a third sequence of commands from the command log to at least one of the first and second client devices, the third sequence of commands comprising an ordered sequence of the at least one of the commands from the first sequence of commands and the at least one of the commands from the second sequence of commands that were inserted into the command log.

2. The method of claim 1, further comprising prior to the server receiving the first sequence of commands from the first client device:
receiving at the first client device the first sequence of commands from a user of the first client device;
sequentially applying by the first client device the first sequence of commands to a current state of the object at the first client device; and
storing by the first client device the first sequence of commands in a work log at the first client device.

3. The method of claim 2, further comprising subsequent to the server transmitting the third sequence of commands to the first client device:
restoring a current state of the object at the first client device to a state that existed immediately prior to applying the first sequence of commands;
removing the first sequence of commands from the work log; and
applying the third sequence of commands to the current state of the object at the first client device.

4. The method of claim 1, further comprising prior to the server receiving the first sequence of commands from the first client device, receiving at the first client device the first sequence of commands from a user of the first client device.

5. The method of claim 4, further comprising subsequent to the server transmitting the third sequence of commands to the first client device, applying by the first client device the third sequence of commands to a current state of the object at the first client device.

6. The method of claim 2, wherein updating the command log further comprises labeling the at least one inserted command from the first sequence of commands as originating from the first client device and labeling the at least one inserted command from the second sequence of commands as originating from the second client device.

7. The method of claim 6, wherein the third sequence of commands includes commands from the first sequence of commands which conflict with commands from the second sequence of commands.

8. The method of claim 7, further comprising subsequent to the server transmitting the third sequence of commands to the first client device:
determining by the first client device a first candidate state of the object at the first client device by determining a previous state of the object at the first client device that existed immediately prior to applying the first sequence of commands, applying the third sequence of commands to the previous state of the object at the client device except for the conflicting commands within the third sequence, and for the conflicting commands, applying only the commands from the first sequence to the previous state of the object;
determining by the first client device a second candidate state of the object at the first client device by applying the third sequence of commands to the previous state of the object at the first client device except for the conflicting commands within the third sequence, and for the conflicting commands, applying only the commands from the second sequence to the previous state of the object; and
either simultaneously displaying in a side-by-side manner or displaying in a temporally successive manner, representations of the object in the first and second candidate states on a display of the first client device.

9. The method of claim 8, further comprising:
receiving by the first client device a selection of the first candidate state from a user of the first client device;
transmitting, from the first client device to the server, information that indicates the conflicting commands were resolved in favor of the first sequence of commands;
receiving a fourth sequence of commands from the server, the fourth sequence of commands including the third sequence of commands except with any conflicting commands within the third sequence replaced with commands from the first sequence;
restoring the current state of the object at the first client device to the previous state of the object that existed immediately prior to applying the first sequence of commands;
removing the first sequence of commands from the work log; and
applying the fourth sequence of commands to the current state of the object at the first client device.

10. The method of claim 9, further comprising:
receiving, by the server, information that indicates the conflicting commands were resolved in favor of the first sequence of commands;
for conflicting commands in the command log, deleting commands that belong to the second sequence of commands from the command log; and
transmitting the fourth sequence of commands from the command log to the second client device.

11. A distributed computing system including a first client device, a second client device and a server, the first client device and the second client device each communicatively coupled to the server, the server configured to:
receive a first sequence of commands relating to an object at the first client device from the first client device;
receive a second sequence of commands relating to an object at the second client device from the second client device;
update a command log based on the first and second sequence of commands, wherein updating the command log comprises inserting at least one of the commands from the first sequence and at least one of the commands from the second sequence into the command log, the inserted commands being ordered with respect to each other based on a sequence identifier associated with each of the commands in the first and second sequence of commands; and
transmit a third sequence of commands from the command log to at least one of the first and second client devices.

12. The distributed computing system of claim 11, wherein the first client device is further configured to, prior to the server receiving the first sequence of commands from the first client device:
receive the first sequence of commands from a user of the first client device;
sequentially apply the first sequence of commands to a current state of the object at the first client device; and
store the first sequence of commands in a work log at the first client device.

13. The distributed computing system of claim 12, wherein the first client device is further configured to, subsequent to the server transmitting the third sequence of commands to the first client device:
restore a current state of the object at the first client device to a state that existed immediately prior to applying the first sequence of commands;
remove the first sequence of commands from the work log; and
apply the third sequence of commands to the current state of the object at the first client device.

14. The distributed computing system of claim 11, wherein the first client device is further configured to, prior to the server receiving the first sequence of commands from the first client device, receive the first sequence of commands from a user of the first client device.

15. The distributed computing system of claim 14, wherein the first client device is further configured to, subsequent to the server transmitting the third sequence of commands to the first client device, apply the third sequence of commands to the current state of the object at the first client device.

16. The distributed computing system of claim 11, wherein updating the command log further comprises labeling the at least one inserted command from the first sequence of commands as originating from the first client device and labeling the at least one inserted command from the second sequence of commands as originating from the second client device.

17. The distributed computing system of claim 16, wherein the third sequence of commands includes commands from the first sequence of commands which conflict with commands from the second sequence of commands.

18. The distributed computing system of claim 17, wherein the first client device is further configured to, subsequent to the server transmitting the third sequence of the commands to the first client device:
determine a first candidate state of the object at the first client device by determining a previous state of the object at the first client device that existed immediately prior to applying the first sequence of commands, applying the third sequence of commands to the previous state of the object at the first client device except for the conflicting commands within the third sequence, and for the conflicting commands, applying only the commands from the first sequence to the previous state of the object at the first client device;
determine a second candidate state of the object at the first client device by applying the third sequence of commands to the previous state of the object at the client device except for the conflicting commands within the third sequence, and for the conflicting commands, applying only the commands from the second sequence to the previous state of the object at the first client device; and
either simultaneously display in a side-by-side manner or display in a temporally successive manner, representations of the object at the first client device in the first and second candidate states on a display of the first client device.

19. The distributed computing system of claim 18, wherein the first client device is further configured to:
receive a selection of the first candidate state from a user of the first client device;
transmit to the server information that indicates the conflicting commands were resolved in favor of the first sequence of commands;
receive a fourth sequence of commands from the server, the fourth sequence of commands including the third sequence of commands except with any conflicting commands within the third sequence replaced with commands from the first sequence;
restore the current state of the object at the first client device to the previous state that existed immediately prior to applying the first sequence of commands;
remove the first sequence of commands from the work log; and
apply the fourth sequence of commands to the current state of the object at the first client device.

20. The distributed computing system of claim 19, wherein the server is further configured to:
receive information that indicates the conflicting commands were resolved in favor of the first sequence of commands;
for conflicting commands in the command log, delete commands that belong to the second sequence of commands from the command log; and
transmit the fourth sequence of commands from the command log to the second client device.
